(19) United States
(12) Patent Application Publication
(10) Pub. No.: US 2002/0186561 A1
(43) Pub. Date: Dec. 12, 2002

(54) ARCHITECTURAL LIGHT

(76) Inventor: Tan Giudicelli, Miami, FL (US)

Correspondence Address: SHUTTS & BOWEN LLP, Henry S. Kaplan, Esq., 1500 Miami Center, 201 South Biscayne Boulevard, Miami, FL, 33131, US

(21) Appl. No.: 09/876,785

(22) Filed: Jun. 7, 2001

(51) Int. Cl. F21S 13/10; F21S 13/14

(52) U.S. Cl. 362/249; 362/252; 362/431; 362/806

(57) ABSTRACT

An architectural light includes a base, a plurality of upstanding, rigid, flexible support elements extending upwardly from the base, and a plurality of illuminating elements. The support elements are generally parallel to one another. The illuminating elements are affixed to about a top portion of at least selective ones of the upstanding support members. The upstanding support members have varying heights upward from the base.

### BACKGROUND OF THE INVENTION

This invention pertains to an architectural light. More particularly, the present invention pertains to an architectural light that can be used indoor or outdoor and can be configured to vary its visual appearance by reaction to wind.

Many types of architectural lamps are known. For indoor use, these lamps range from table lamps to floor lamps to wall mounted lamps such as sconces and the like. Many of these lamps are artistic in nature and are for visual or aesthetic effect, as well as for illumination purposes.

Outdoor lighting, on the other hand, is much more limited. Typically, outdoor lights are wall or surface mounted, such as to the outside wall of the house, or mounted in the ground. Typical ground-mounted lights include a tapered or pointed support stake portion that is “planted” into the ground and includes a light at an upper portion, above the support stake. Although different types of ground mounted lights have come into popular, widespread use, they commonly share this “planted” design.

One drawback to commonly known ground mounted lighting systems is that the illumination provided by the individual lights is limited to the wattage of the bulb and the light fixture. If additional illumination is desired, typically a plurality of such ground mounted fixtures must be used. While this arrangement may provide the desired illumination, a grouping of these lights may not provide an aesthetically appealing visual effect. That is, an area in which a group of lights may be closely “planted” to one another may detract from an overall, desired visual effect.

In addition, the types of fixtures are somewhat limited. That is, typically, these fixtures include standard up-lights, tiered lights and carriage lights. All of these types of lights are similar in that a large fixture portion is mounted to a “planted” support stake.

Accordingly, there exists a need for an architectural light that can provide increased illumination in a relatively small area. Desirably, such a light includes a plurality of illuminating devices or bulb within a relatively small “footprint”. Most desirably, such a light is configured to include a base such that a plurality of bases can be affixed to the ground adjacent one another to provide both a visually appealing effect, as well as a desired illumination.

### BRIEF SUMMARY OF THE INVENTION

An architectural light includes a base, a plurality of upstanding, rigid, flexible support elements extending upwardly from the base, and a plurality of illuminating elements. The support elements extend upwardly, generally parallel to one another.

The illuminating elements are affixed to about a top portion of at least selective ones of the upstanding support members. Each of the upstanding support members can include an illuminating device affixed to the top thereof. Alternately, less than all of the upstanding members can have an illuminating device affixed to the top.

The upstanding support members can have varying heights upward from the base. Preferably, at least some of upstanding members have heights equal to one another.

The base can be configured in differing shapes. In a current embodiment, the base has a rectangular shape. Alternately, the base can have an irregular shape, such as a kidney-shape.

The light base can be an environmentally sealed unit. Such a light can be used outdoors to provide a desired aesthetic effect in, for example a garden.

These and other features and advantages of the present invention will be apparent from the following detailed description, in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is perspective view of an architectural light embodying the principles of the present invention;

FIG. 2 is a plan view of the light of FIG. 1;

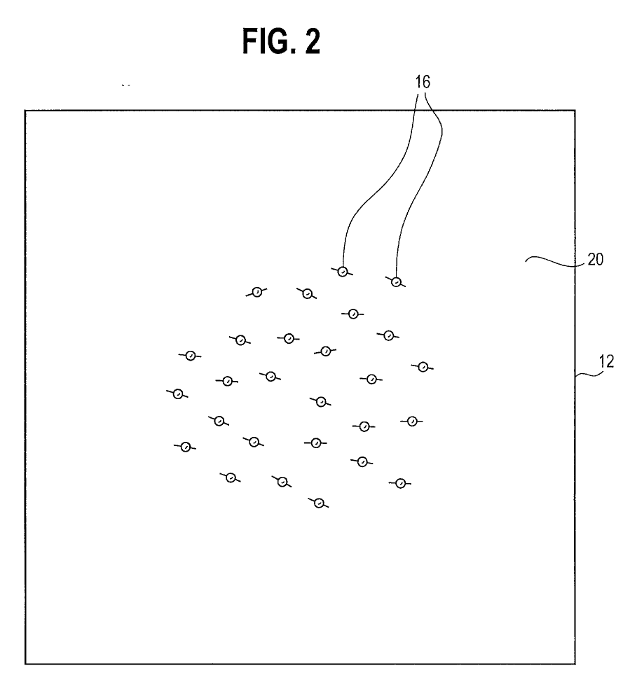

FIG. 3 is a representative elevational view of the light; and

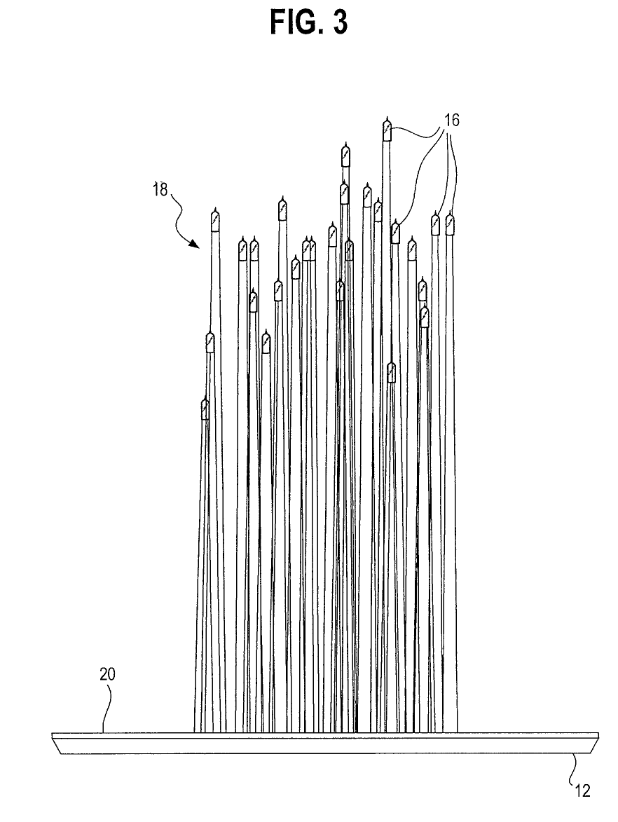

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of the specification, namely, “Detailed Description Of The Invention”, relates to a requirement of the United States Patent Office, and does not imply, nor should be inferred to limit the subject matter disclosed and claimed herein.

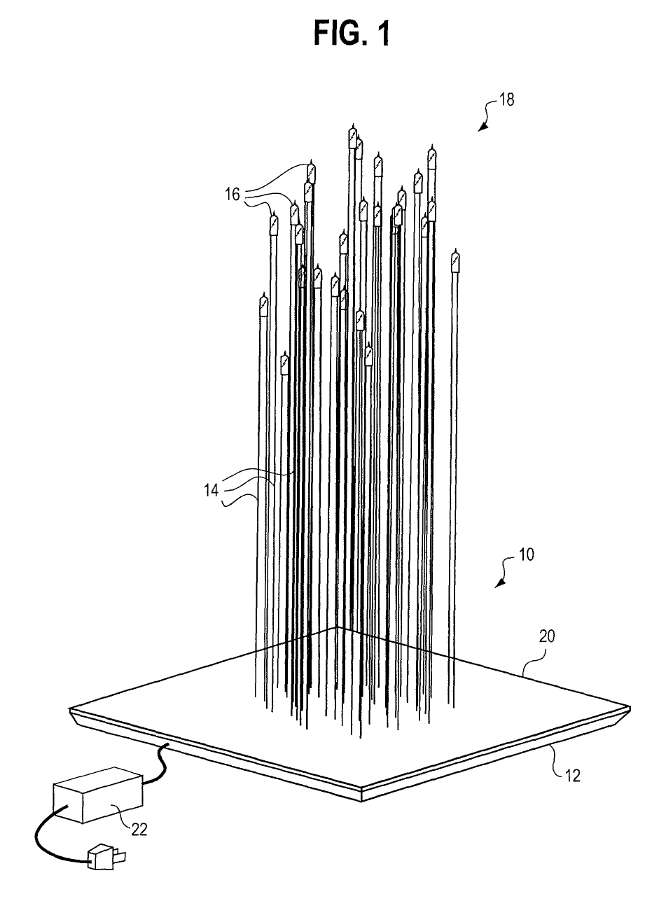

Referring to the figures and in particular to FIG. 1, there is shown one embodiment of an architectural light 10 in accordance with the principles of the present invention. The light 10 includes a base portion 12 and a plurality of upstanding rigid, yet flexible elements 14 mounted to the base 12 that extend upwardly therefrom. Illuminating devices 16 are affixed to the top 18 of at least some of the upstanding elements 14.

The present architectural light 10 provides illumination as well as an aesthetically or visually appealing effect. That is, the light 10 itself is an artistic object, and thus is visually appealing in nature. Unlike known lighting devices, which tend to “look” like lighting devices, the present architectural light 10 appears more to be a work of art rather than a lighting or illuminating device.

In a present embodiment, the base 12 can be formed having a number of different shapes depending upon a desired effect. For example, the base 12 can be rectangular in shape which lends itself to placing multiple light units 10 adjacent to one another to effect a relatively large area of the architectural lights 10. In such an arrangement, the various base 12 sections can be connected to one another electrically so that they are commonly controlled. Alternately, certain ones of the base units 12 can be connected to one another so that they are commonly controlled, separate and apart from others of the adjacent units 10.

In another configuration, the base 12 can be designed having an irregular shape (not shown). One example would be a “kidney-shaped” base. Such a base design lends itself further to appearance as a artistic object, rather than a light. Various other base 12 shapes could well be imagined by one skilled in the art, all of which shapes are within the scope and spirit of the present invention.

In an embodiment of the architectural light 10, in which the light 10 is intended for outdoor use, the base 12 can be formed from any known environmentally impervious material. For example, the base 12 can be formed from a polymeric material, such polystyrene or the like. The base 12 can also include, for example, other materials thereon (e.g., mounted or affixed to an upper surface, as illustrated at 20) such as artificial turf and the like. Such an effect permits use of the architectural light 10 within a sodded or planted area in which the base 12 can “blend” in with its surroundings.

In a current embodiment, the upstanding members 14 are sufficiently rigid to remain erect, while at the same time they are sufficiently flexible such that they will readily wave or move in a breeze or wind. In this manner, the light 10 can provide an effect of being a part of its outdoor natural environment much in the way that tall grasses will readily wave in a breeze or wind. The upstanding members 14 can also be formed of a material such that they remain upstanding and do not move or “wave” in response to wind.

In a current embodiment, the upstanding elements 14 are formed of metal. However, other materials are contemplated, such as plastic or polymeric materials and the like. Again, such other materials are within the scope and spirit of the present invention.

As best seen in FIG. 1, the heights as exemplified by H₁, H₂, H₃ of the upstanding members 14 vary. That is, there is a range of heights H of the members 14, rather than a single height. This too provides a “natural” effect lending the architectural light 10 once again to appear as part of the overall outdoor environment. The relative heights H of the upstanding members 14 can vary such that they are all within a desired range or span. Alternately, the heights H of the members 14 can vary significantly to provide a more random feel and effect for the illuminating elements 16.

The illuminating elements 16 can take many forms. As will be recognized by those skilled in the art, small outdoor incandescent bulbs can be used to provide illumination for the light 10. Alternately, light emitting diodes and the like can also be used, as can other (non-incandescent) types of light bulbs. It is envisioned that the bulbs 16 can be of the type that are merely inserted into or pulled from a socket (not shown) that is designed for outdoor use. In such an arrangement, a variety of different types as well as colors of bulbs or lighting elements 16 can be used as can a range of element 16 wattages.

In a present embodiment, each of the upstanding elements 14 has a lighting element 16 mounted to the top 18 thereof. Alternately, the lights 16 can be interspersed among the upstanding elements 14 such that fewer than all of the elements 14 include lights 16. This, again, can provide a different aesthetic effect.

As will be recognized by those skilled in the art, the electrical connection for such a light 10 is relatively straight forward. The connections can be direct connections in which all of the illuminating elements 16 are constantly illuminated when power is supplied thereto. Alternately, the elements 16 can be configured to blink or “twinkle” when powered. All of these arrangements can provide different visual effects, as desired. All such electrical connections and arrangements will be recognized and appreciated by those skilled in the art and are within the scope and spirit of the present invention.

As will also be recognized by those skilled in the art, various power sources (not shown) for the architectural light 10 can be used. In one embodiment, a low voltage power source 22 is provided for the light. Other power sources can be used that provide “house-hold” voltage (e.g., 120 or 240 volts) for the light.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

What is claimed is:

1. An architectural light comprising:
a base;
a plurality of upstanding, rigid, flexible support elements extending upwardly from the base, the support elements being generally parallel to one another; and
a plurality of illuminating elements, the illuminating elements being affixed to about a top portion of at least selective ones of the upstanding support members.

2. The architectural light in accordance with claim 1 wherein the upstanding support members have varying heights upward from the base.

3. The architectural light in accordance with claim 1 wherein at least some of upstanding members have heights equal to one another.

4. The architectural light in accordance with claim 1 wherein each of the upstanding support members has an illuminating device affixed to about a top thereof.

5. The architectural light in accordance with claim 1 wherein less than all of the upstanding members have an illuminating device affixed to the top thereof.

6. The architectural light in accordance with claim 1 wherein the base has a rectangular shape.

7. The architectural light in accordance with claim 1 wherein the base has an irregular shape.

8. The architectural light in accordance with claim 7 wherein the base has a kidney-shape.

9. The architectural light in accordance with claim 1 wherein the base is an environmentally sealed unit.
